(19) United States
(12) Patent Application Publication
(10) Pub. No.: US 2012/0235831 A1
(43) Pub. Date: Sep. 20, 2012

(54) POSITION DETECTION SYSTEM AND POSITION DETECTION SENSOR

(75) Inventor: Koji CHINDO, Saitama (JP)

(73) Assignee: Seiko Epson Corporation, Tokyo (JP)

(21) Appl. No.: 13/420,951

(22) Filed: Mar. 15, 2012

(30) Foreign Application Priority Data
Mar. 18, 2011 (JP) 2011-060629

(51) Int. Cl. G08C 15/06

(52) U.S. Cl. 340/870.02

(57) ABSTRACT

A position detection sensor which includes a first atomic oscillator and a sensor-side transmitter, and outputs a sensor output signal, a base station apparatus which includes a base station-side receiver, which wirelessly receives the sensor output signal, and a second atomic oscillator, a comparator which compares the phase of an output signal from the first atomic oscillator and the phase of an output signal from the second atomic oscillator, and outputs a phase comparison signal, a storage which stores a defined value of the phase comparison signal, and a displacement detector which detects displacement of the position detection sensor by comparing the phase comparison signal and the defined value are included.

### BACKGROUND

1. Technical Field

The present invention relates to a position detection system, a position detection sensor and the like.

2. Related Art

An observation system, in which a transmitter is installed in an object to be measured (for example, the ground where a cliff failure may occur), is used to detect the signs of a cliff failure, earthquake, the collapse of a structural object, or the like. On the side of a receiver, the signs of such a disaster are detected based on variations in signals from the transmitter, thereby being helpful in the prevention of disaster. For example, the invention of JP-A-9-243412 discloses a system which includes a transmitter that emits ultrasound waves, and a receiver.

Here, in consideration of a case where a transmitter is installed on a cliff, it is preferable that transmission and reception be performed wirelessly instead of using a wire, such as a cable or the like. In this case, sound waves are used in the system of the invention of JP-A-9-243412, and it is necessary that the frequency thereof be higher than the audible region of a person. Further, the upper limit frequency, which is determined based on phase difference determination resolution, is 50 kHz in real (refer to paragraph [0036] of JP-A-9-243412). Therefore, only a very narrow frequency band of 20 kHz to 50 kHz can be used, so that there is a problem of usability. Further, it is necessary to provide both an ultrasonic circuit and a wireless circuit, so that there are problems of complicated configuration of the system and high cost.

Further, it is important that the signs of a cliff failure, earthquake, the collapse of a structural object, or the like are detected as early as possible in order to secure time for evacuation or the like. For example, it is preferable to be able to detect not only sudden changes immediately before the collapse, but also extremely gradual landslides or the like, which may occur a few days before the collapse. Here, in such an observation system, the transmitter includes a motion sensor, such as an acceleration sensor, and the output thereof may be transmitted. However, with respect to the landslide which is extremely gradual, the movement thereof cannot be detected, so that the signs thereof may be missed. Therefore, a system which can highly accurately detect the position of an object is necessary.

### SUMMARY

An advantage of some aspects of the invention is to provide a position detection system and a position detection sensor which can be easily installed at low cost, and which have high detection sensitivity.

(1) An aspect of the invention is directed to a position detection system including a position detection sensor which includes a first atomic oscillator and a sensor-side transmitter, and outputs a sensor output signal; a base station apparatus which includes a base station-side receiver, which wirelessly receives the sensor output signal, and a second atomic oscillator; a comparator which compares the phase of an output signal from the first atomic oscillator and the phase of an output signal from the second atomic oscillator, and outputs a phase comparison signal; a storage which stores a defined value of the phase comparison signal; and a displacement detector which detects displacement of the position detection sensor by comparing the phase comparison signal and the defined value.

(2) In the position detection system, the base station apparatus may include the comparator, the storage, and the displacement detector.

(3) In the position detection system, the position detection sensor may include a sensor-side receiver which wirelessly receives a reference signal from the base station apparatus; the comparator which compares the reference signal with the output signal from the first atomic oscillator, and then outputs the phase comparison signal; the displacement detector; the storage; and the sensor-side transmitter which wirelessly transmits the output signal of the displacement detector as the sensor output signal, and the base station apparatus may include the base station-side receiver which wirelessly receives the sensor output signal; and a base station-side transmitter which generates the reference signal based on output from the second atomic oscillator, and wirelessly transmits the reference signal.

(4) In the position detection system, the position detection sensor may include the comparator; and the sensor-side transmitter which wirelessly transmits the phase comparison signal as the sensor output signal, and the base station apparatus may include the storage; the base station-side receiver which wirelessly receives the phase comparison signal which is wirelessly transmitted from the sensor-side transmitter; and the displacement detector which detects the displacement of the position detection sensor by comparing the phase comparison signal which is wirelessly received using the base station-side receiver with the defined value of the phase comparison signal.

According to the aspect of the invention, the accuracy of the phase comparison is improved by using the high accurate atomic oscillator, so that the position detection system which is capable of measuring minute displacement and which has high detection sensitivity can be realized. Further, since the transmission and reception are wirelessly performed, installation thereof is easy. Further, a signal in a frequency band which is used for wireless can be handled as is by using a circuit or the like which realizes, for example, a comparator. Unlike the invention of JP-A-9-243412, since an ultrasonic circuit is not necessary, the position detection system can be provided at a low cost.

Especially, it is preferable that the atomic oscillator be of a Coherent Population Trapping (CPT) method. The power consumption thereof is low because of the small size and low cost thereof, and a solar battery can be driven. Since the atomic oscillator is highly accurate and stable, the atomic oscillator is used in the aspect of the invention as the independent frequency source of each of the base station apparatus and the position detection sensor, and the displacement of an object is measured by comparing the phases which are output therefrom. In oscillators (for example, crystal, ceramic, RC, and the like) other than the atomic oscillator, especially, the frequency stability is deteriorated, so that it is difficult to accurately measure minute displacement.

The displacement can be accurately measured by comparing the signal (the phase comparison signal) which is the result of the phase comparison with the defined value of the phase comparison signal. The defined value of the phase comparison signal indicates data based on the phase comparison signal which is obtained through calculation or which is measured in the past. For example, when a frequency shift exists between the position detection sensor and the atomic oscillator of the base station apparatus because of production tolerance, data indicative of the shift can be stored in the storage as the defined value of the phase comparison signal.

Here, the base station apparatus may include the comparator, the storage, and the displacement detector.

At this time, since the position detection sensor includes comparatively small-sized circuits, that is, the first atomic oscillator and the sensor-side transmitter, the position detection sensor can be produced at a small size and low cost.

Further, the base station apparatus may include the base station-side receiver which wirelessly receives the sensor output signal, and the base station-side transmitter which generates the reference signal based on the output from the second atomic oscillator and wirelessly transmits the reference signal.

At this time, since the phase of the output signal from the first atomic oscillator is compared with the phase of the reference signal based on the output from the second atomic oscillator using the position detection sensor, the processing load of the base station apparatus can be reduced. Therefore, if this system is used to increase the number of position detection sensors in the future, a situation in which the entire process is delayed because the processes are centered on the base station apparatus can be avoided.

Further, the position detection sensor may include the comparator and the sensor-side transmitter which wirelessly transmits the phase comparison signal as the sensor output signal, and the base station apparatus may include the storage, the base station-side receiver which wirelessly receives the phase comparison signal which is wirelessly transmitted from the sensor-side transmitter, and the displacement detector which detects the displacement of the position detection sensor by comparing the phase comparison signal which is wirelessly received using the base station-side receiver with the defined value of the phase comparison signal.

The process of comparing the phase comparison signal indicative of the result of the phase comparison with the defined value of the phase comparison signal may be performed on the side of the position detection sensor, and may be performed in the base station apparatus. When this process is performed on the side of the position detection sensor, the processing load of the base station apparatus can be reduced.

Meanwhile, when this process is performed in the base station apparatus, the storage which stores the defined value of the phase comparison signal is not necessary for the position detection sensor. Therefore, compared to the case where this process is performed on the side of the position detection sensor, the position detection sensor can be produced in a small size and at a low cost.

(5) In the position detection system, a plurality of position detection sensors may be provided.

According to the aspect of the invention, a plurality of position detection sensors are installed, so that the signs of a cliff failure, earthquake, the collapse of a structural object or the like can be detected over a wide range. The plurality of position detection sensors are installed, so that the signs of the disaster can be prevented from being missed, thereby being helpful in the prevention of disaster.

(6) In the position detection system, the sensor-side transmitter may include a modulator which modulates the sensor output signal using a frequency which is different for each position detection sensor, and the base station-side receiver may include a demodulator which demodulates the modulated sensor output signal.

According to the aspect of the invention, transmission is performed using a frequency which is different for each position detection sensor by modulating the frequency, so that the base station apparatus can distinguish each of the plurality of position detection sensors.

(7) In the position detection system, the position detection sensor may include a timer which performs timekeeping based on the output from the first atomic oscillator, and each sensor-side transmitter may include a transmission timing controller which controls transmission timing such that the sensor output signal is wirelessly transmitted at a different timing based on output of the timer.

According to the aspect of the invention, a transmission timing, on which time division is performed, is assigned to each position detection sensor, so that the base station apparatus can distinguish each of the plurality of position detection sensors. Here, each of the position detection sensor and the base station apparatus includes the atomic oscillator, and the timer which performs timekeeping based on the output of the atomic oscillator. The atomic oscillator is highly accurate and stable, so that, if the timer is set during, for example, shipping, time keeping is continuously performed for accurate time thereafter. Therefore, the output signals from the plurality of position detection sensors are transmitted to the base station apparatus without collision.

(8) In the position detection system, the base station apparatus may include a base station-side receiver which wirelessly transmits a transmission start signal, used to permit the transmission of the sensor output signal, to the position detection sensor, and each position detection sensor may include a sensor-side transmitter which wirelessly receives the transmission start signal; and each sensor-side transmitter may include a transmission timing controller which receives the transmission start signal from each sensor-side receiver, and controls a transmission timing such that the sensor output signal is wirelessly transmitted at a different timing that is different from that of another position detection sensor based on the transmission start signal.

According to the aspect of the invention, the base station apparatus can receive the output signal from the position detection sensor at a designated timing. The base station apparatus includes the base station-side transmitter, and transmits the transmission start signal used to permit transmission to the position detection sensor. Meanwhile, each position detection sensor includes a sensor-side transmitter, and wirelessly transmits the sensor output signal if a predetermined time elapses after the transmission start signal is received. Each position detection sensor may store unique timing information (transmittable time) in, for example, a nonvolatile memory, and may start wireless transmission after time that is designated in the timing information elapsed when it is determined that the transmission start signal is received. The base station apparatus can distinguish each of the plurality of position detection sensors based on the timing where the sensor output signal is transmitted.

(9) Another aspect of the invention is directed to a position detection sensor which is used in the position detection system.

According to the aspect of the invention, the position detection sensor is fixed to a position detection object, and transmits a sensor output signal which is used to detect the position of the object. The position of the object is detected using the sensor output signal, and the signs of, for example, a cliff failure, earthquake, the collapse of a structural object or the like can be detected.

### BRIEF DESCRIPTION OF THE DRAWINGS

The invention will be described with reference to the accompanying drawings, wherein like numbers reference like elements.

FIG. 1 is a block diagram illustrating a position detection system according to a first embodiment.

FIG. 2A is a block diagram illustrating an atomic oscillator of the CPT method, and FIG. 2B is a block diagram illustrating an atomic oscillator of a double resonance method.

FIG. 3 is a block diagram illustrating a comparator according to the first embodiment.

FIG. 4 is a flowchart illustrating a process performed by the position detection system according to the first embodiment.

FIG. 5 is a block diagram illustrating a position detection system according to a second embodiment.

FIG. 6 is a flowchart illustrating a process performed by the position detection system according to the second embodiment.

FIG. 7 is a block diagram illustrating a position detection system according to a third embodiment.

FIG. 8 is a block diagram illustrating a first modification.

FIG. 9 is a block diagram illustrating a second modification.

FIG. 10 is a block diagram illustrating a third modification.

FIG. 11A is a view illustrating an example of the use of the position detection system, and FIG. 11B is a view illustrating an example of the variation in the phase of a signal between a position detection sensor and a base station apparatus.

### DESCRIPTION OF EXEMPLARY EMBODIMENTS

### 1. First Embodiment

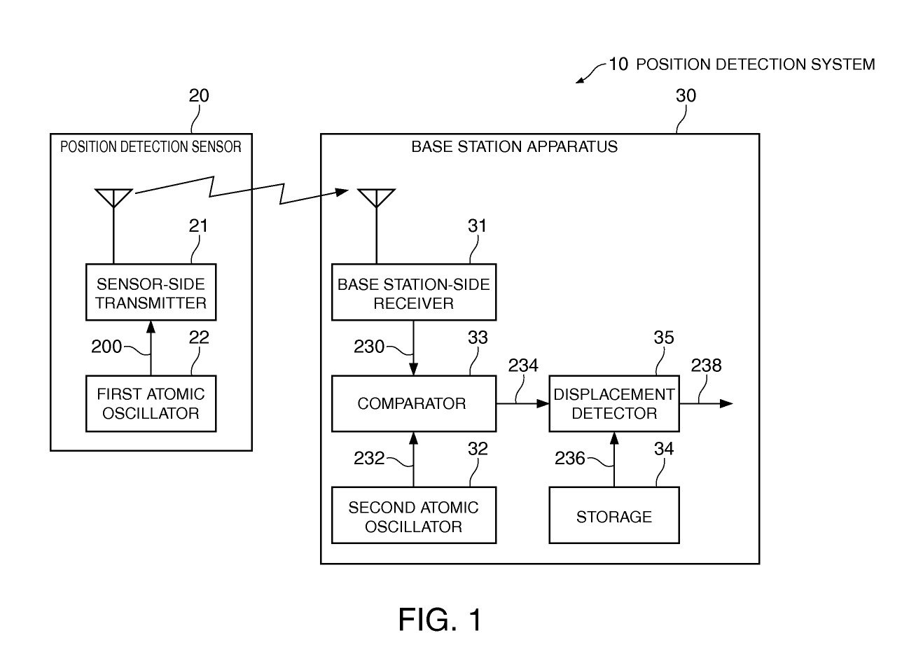

A first embodiment of the present invention will be described with reference to FIGS. 1 to 4 and FIGS. 11A and 11B.

### 1.1. Example of Use of Position Detection System According to First Embodiment

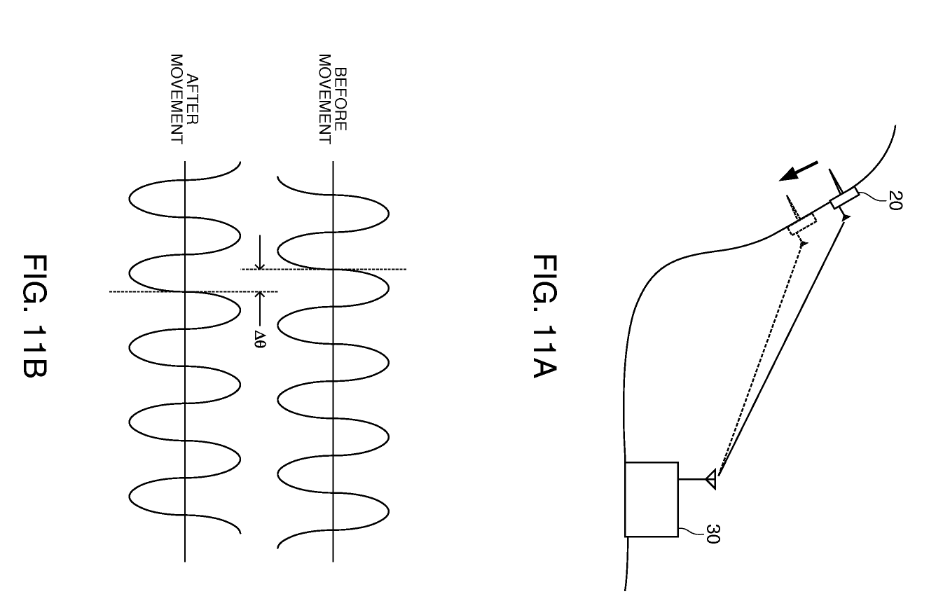

An example of the use of a position detection system according to the first embodiment will be described with reference to FIGS. 11A and 11B. FIG. 11A is a view illustrating an example in which the position detection system is used to detect the signs of a cliff failure. A position detection sensor 20 is fixed to a part of a cliff (ground) using a stake, and wirelessly transmits a sensor output signal to a base station apparatus 30. When there are signs of a cliff failure, the position detection sensor 20 moves together with the ground as shown in a dotted line, so that the distance from the base station apparatus 30 is varied.

FIG. 11B is a view illustrating the variation in the sensor output signal. Before there are signs of a cliff failure, the position detection sensor 20 is present at the position of the solid line of FIG. 11A and the base station apparatus receives a sensor output signal indicated by “before movement” of FIG. 11B. However, after the position detection sensor 20 is moved together with the ground, the base station apparatus 30 receives a sensor output signal indicated by “after movement” of FIG. 11B. The base station apparatus 30 can know the amount of the movement of the position detection sensor 20 by detecting, for example, the phase difference Δθ between the sensor output signal “before movement” and the sensor output signal “after movement”, and can respond to the cliff failure based on the result of the detection. In the position detection system, for example, the stability of the sensor output signal, high accuracy in the case of detecting the variation in phases, and measures for preventing of the miss of signs and false detection from being performed are necessary. The position detection system according to the first embodiment realizes the stability of the signal and high accuracy by using an atomic oscillator. Further, signs are prevented from being missed by detecting a position instead of acceleration, and the accuracy of detection is improved by performing comparison with a defined value.

### 1.2. Configuration of Position Detection System According to First Embodiment

FIG. 1 is a block diagram illustrating a position detection system 10 according to the first embodiment. The position detection system 10 includes the position detection sensor 20 and the base station apparatus 30.

The position detection sensor 20 includes a sensor-side transmitter 21 and a first atomic oscillator 22. The sensor-side transmitter 21 wirelessly transmits a sensor output signal. In the first embodiment, the sensor output signal may be output 200 of the first atomic oscillator. The output 200 of the first atomic oscillator is a clock signal having a predetermined frequency. The first atomic oscillator 22 is an atomic oscillator of a Coherent Population Trapping (CPT) method, and is suitable for configuring the position detection sensor 20 because of the small size and low cost thereof, and the power consumption thereof is low. The first atomic oscillator 22 will be described in detail later.

The base station apparatus 30 includes a base station-side receiver 31, a second atomic oscillator 32, a comparator 33, storage 34, and a displacement detector 35.

The base station-side receiver 31 wirelessly receives the sensor output signal from the position detection sensor 20. The second atomic oscillator 32 is an atomic oscillator which is the same as the first atomic oscillator 22, the size thereof is small size, the cost there of is low, and the power consumption thereof is low. In the first embodiment, although output 232 of the second atomic oscillator is a clock signal which has the same frequency as that of the output 200 of the first atomic oscillator, the frequencies thereof are not necessarily the same. The comparator 33 receives a sensor output signal 230 from the base station-side receiver 31, compares the phase of the sensor output signal 230 with the phase of the output 232 of the second atomic oscillator, and outputs a phase comparison signal 234 which is the result of the comparison. The process performed by the comparator 33 will be described in detail later.

Here, although the phase comparison signal 234 provides phase difference depending on the movement distance of the position detection sensor 20, it is preferable to include a unit which can further improve detection accuracy when the unique information of the sensor, such as the individual difference or aging of the position detection sensor 20 is taken into consideration. The displacement detector 35 outputs a signal 238 indicative of the accurate displacement of an object by further comparing the phase comparison signal 234 with a defined value 236 of the phase comparison signal which is stored in the storage 34. The defined value 236 of the phase comparison signal will be described later.

### 1.3. Atomic Oscillator

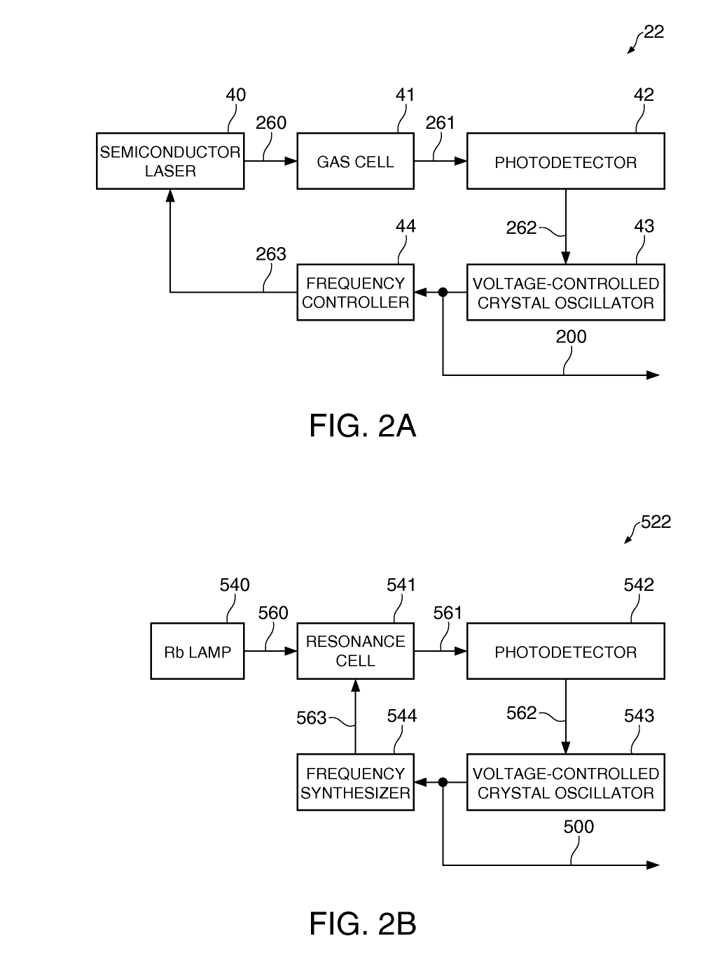

Here, the atomic oscillator in CPT method will be described while comparing with an atomic oscillator in double resonance method which is a comparison example. FIG. 2A is a block diagram illustrating the first atomic oscillator 22, that is, the atomic oscillator in CPT method. The first atomic oscillator 22 includes a semiconductor laser 40, a gas cell 41, a photodetector 42, a voltage-controlled crystal oscillator 43, and a frequency controller 44, and the output 200 of the first atomic oscillator may be, for example, the output from the voltage-controlled crystal oscillator 43.

An alkali metal atom which includes quantum absorbers, such as a rubidium atom and a cesium atom, is enclosed in the gas cell 41. The semiconductor laser 40 generates two types of laser light, the frequencies of which are different from each other, and transmits the laser light to the gas cell 41. The first atomic oscillator 22 can be aware of the amount of incident light 260, which is incident to the gas cell 41 and then absorbed by the gas of the alkali metal atom, by detecting transmitted light 261 in the photodetector 42 which is provided in the opposite side of the gas cell 41. The photodetector 42 adjusts the oscillating frequency of the voltage-controlled crystal oscillator 43 by changing control voltage 262 depending on the amount detected of the transmitted light 261. The frequency controller 44 outputs a modulation signal 263 based on the oscillating frequency of the voltage-controlled crystal oscillator 43, and outputs laser light, on which modulation is performed, to the semiconductor laser 40.

Although the quantum absorber of the gas cell 41 absorbs the incident laser light, light absorption characteristics (transmittance) are changed based on the difference in the frequencies of the two types of laser light. An Electromagnetically Induced Transparency (EIT) phenomenon in which neither of the two types of light is absorbed and transmitted when the difference in the frequencies of the two types of laser light corresponds to a specific value has been known. The EIT phenomenon is used in CPT method. When one or both frequencies of the two types of laser light are changed, a state in which light absorption stops in the gas cell 41 is detected and used as the oscillator.

Meanwhile, FIG. 2B is a block diagram illustrating an atomic oscillator in double resonance method which is a comparison example. An atomic oscillator 522 of the comparison example includes a rubidium (Rb) lamp 540, a resonance cell 541, a photodetector 542, a voltage-controlled crystal oscillator 543, and a frequency synthesizer 544. For example, output 500 of the atomic oscillator may be the output of the voltage-controlled crystal oscillator 543.

The photodetector 542 detects transmitted light 561, and changes control voltage 562 depending on amount detected, thereby adjusting the oscillating frequency of the voltage-controlled crystal oscillator 543, like the first atomic oscillator 22. However, incident light 560 is radiated from the rubidium (Rb) lamp 540 using a rubidium atom and the rubidium atom is enclosed in the resonance cell 541. When the incident light 560 does not exist, two rubidium ground levels F=1 and F=2 exist with almost equivalent probabilities. For example, if only light, which has a center wavelength of 795 nm and which is almost equivalent to the energy difference between the level F=1 and an excitation level, is radiated as pumping light using a filter (not shown), only a rubidium atom which exists in the level F=1 transits to the excitation level. Thereafter, the excitation level rubidium atom releases light and transits to the ground levels F=1 and F=2 with almost equivalent probabilities. If the pumping light is repeatedly radiated, the rubidium atom becomes only the state F=2, and the incident light 560 is not absorbed. At this time, the maximum transmitted light 561 is detected. In this state, if the frequency synthesizer 544 irradiates a microwave 563 of 6.8 GHz which is generated based on the output of the voltage-controlled crystal oscillator 543, a plurality of rubidium atoms are transited to the state F=1, so that the transmitted light 561 reduces. The atomic oscillator 522 of the comparison example uses this variation as an oscillator.

Here, it is necessary that the resonance cell 541 of the atomic oscillator 522 of the comparison example functions as a microwave resonator which is used to generate a microwave which is suitable for the excitation of an atom as well as the gas cell in which the rubidium atom is enclosed. When it is assumed that the wavelength of a microwave is λ, it is necessary that the size of the resonance cell is at minimum of λ/2 such that an ordinary wave is generated in the resonator. In detail, it is necessary that the size of the resonance cell 541 is at minimum of 2 cm.

Meanwhile, it is not necessary to use microwave in the first atomic oscillator 22, that is, in the atomic oscillator in CPT method, so that there is no limitation in miniaturization as described above. Further, a semiconductor laser is used instead of the rubidium lamp, so that driving is possible using a battery. Therefore, the size of the atomic oscillator of the CPT method is small and the power consumption thereof is low. Therefore, the atomic oscillator can be installed in the position detection sensor which is fixed to, for example, the ground using a stake, and is suitable for the position detection system of the embodiment of the invention because of high accuracy.

Meanwhile, although the first atomic oscillator 22 has been described here, the atomic oscillator in CPT method may be used for the second atomic oscillator 32 in the same manner.

### 1.4. Comparator

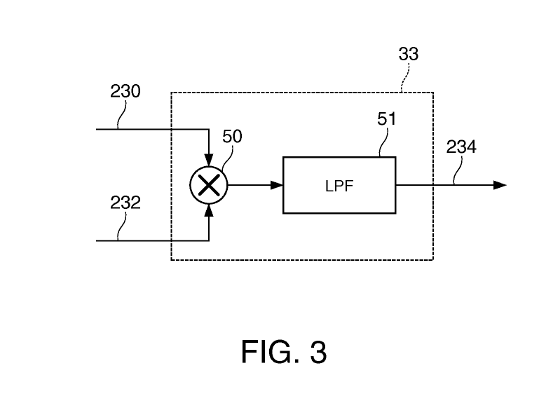

FIG. 3 is a block diagram illustrating the comparator 33 according to the first embodiment. In the first embodiment, the base station apparatus 30 compares the phase of the sensor output signal 230 and the phase of the output 232 of the second atomic oscillator using the comparator 33, and outputs the phase comparison signal 234 which is the result of the comparison. The comparator 33 includes a mixer 50 and a Low-Pass Filter (LPF) 51.

For example, when it is assumed that the frequency of the output 200 (that is, the sensor output signal 230) of the first atomic oscillator is the same as the frequency of the output 232 of the second atomic oscillator, the output signal 230 (V1) and the output 232 (V2) of the second atomic oscillator can be expressed as, for example, the following Equations 1 and 2. Here, A and B indicate respective amplitudes, and d indicates phase difference.

V₁(t)=A sin(ωt+d) (1)

V₂(t)=B sin(ωt) (2)

A signal (Vm) shown in the following Equation 3 can be obtained using the mixer 50.

$${V}_{m} ( t ) = \frac{AB}{2} \{ cos ( d ) - cos ( 2 ω t + d ) \} \qquad ( 3 )$$

Since high-frequency components are removed by the low-pass filter 51, the phase comparison signal 234 (Vp) is expressed using a direct-current component equation such as the following Equation 4.

$${V}_{p} ( t ) = \frac{AB}{2} cos ( d ) \qquad ( 4 )$$

Here, when the position detection sensor 20 is displaced from the position where the position detection sensor 20 is installed, the distance between the position detection sensor 20 and the base station apparatus 30 is varied, so that the phase of the sensor output signal 230 is varied (refer to the phase difference Δθ of FIG. 11B). That is, d of Equation is varied. The displacement detector 35 detects the variation, so that it can be determined that the position detection sensor 20 is moved.

### 1.5. Memory and Displacement Detector

Description will be made with reference to FIG. 1 again. Data, which is used to accurately measure the amount of the movement of an object, is stored in the storage 34 according to the first embodiment, and is input to the displacement detector 35 as the defined value 236 of the phase comparison signal. For example, the displacement detector 35 compares the obtained phase comparison signal 234 with the defined value 236 of the phase comparison signal, determines that the object is moved when the difference therebetween is equal to or greater than a threshold, and then calculates displacement. When the difference therebetween is less than the threshold, it can be determined that the object is not moved. When the storage and the displacement detector are used, the movement of the object can be accurately determined and the correction of aging or the like can be performed as described later.

The data which is stored in the storage 34 may be, for example, an expectation value obtained using Equation 4, and may be a value based on the phase comparison signal 234 obtained when the position detection sensor 20 is initially installed. Further, the data in the storage 34 may be overwritten using the actual measurement value of the phase comparison signal 234 at every predetermined time interval. A plurality of data may be stored and a part of the data may be selected and then input to the displacement detector 35 as the defined value 236 of the phase comparison signal.

The displacement detector 35 according to the first embodiment compares the defined value 236 of the phase comparison signal with the phase comparison signal 234, and outputs the signal 238 indicative of the displacement of the object. The signal 238 indicative of the displacement of the object may be a signal which has a value corresponding to the amount of displacement, and may be a binary signal indicative of whether the object is displaced or not. Further, the signal 238 indicative of the displacement of the object may be output to the outside of the base station apparatus 30, may be stored in, for example, an internal or external storage apparatus of the base station apparatus 30. Further, the base station apparatus 30 may give a warning against disaster or may connect to a predetermined agency based on the result of a process of performing comparison on a threshold, or the like.

### 1.6. Aging Correction

Frequency shift attributable to aging (temporal change) or the like can be handled by providing the storage 34 and the displacement detector 35. For example, when the frequency shift exists because of aging or production tolerance, the output signal 230 (V1) can be expressed as in the following Equation 5 instead of Equation 1.

V₁(t)=A sin(ωt+pt+d) (5)

Then, since the phase comparison signal 234 (Vp) is obtained by substituting pt+d for d in Equation 4, the phase comparison signal 234 (Vp) becomes a cosine wave as in the following Equation 6.

$${V}_{p} ( t ) = \frac{AB}{2} cos ( pt + d ) \qquad ( 6 )$$

The position detection system 10 according to the first embodiment does not determine the displacement of the object using only the variation in the phase comparison signal 234 and performs comparison on the defined value of the phase comparison signal 234 using the displacement detector 35. Therefore, even when the frequency shift exists between the output signal 230 (V1) and the output 232 (V2) of the second atomic oscillator, the displacement of the object can be accurately determined. In this example, since the fact that the phase comparison signal 234 becomes the cosine wave of Equation 6 is stored in the storage 34 as the data, the displacement detector 35 can accurately perform determination.

In this example, the data stored in the storage 34 may be, for example, a set of time that a waveform intersects 0V with a positive inclination in Equation 6. For example, the data may be the data D of the following Equation 7 where N is a natural number.

$$D = \{ \frac{3}{2 p} π - \frac{d}{p} , \frac{7}{2 p} π - \frac{d}{p} , … , \frac{4 N - 1}{2 p} π - \frac{d}{p} \} \qquad ( 7 )$$

As a specific example, when the frequency of the output 200 of the first atomic oscillator (that is, the sensor output signal 230) is relatively shifted from the frequency of the output 232 of the second atomic oscillator by 10-10, Vp is a signal which has a cycle of 66 seconds, and the element (data) of Equation 7 has an interval of 66 seconds. Here, since the phase of the phase comparison signal 234 is shifted when the object moves, the interval that the phase comparison signal 234 intersects 0V with a positive inclination is varied. For example, the displacement detector 35 can measure the displacement of the object by measuring the voltage of the phase comparison signal 234 at every time that the 0V is intersected, and measuring the variation in the voltage from 0V.

In the first embodiment as described above, even when the frequency of the output 200 of the first atomic oscillator is different from the frequency of the output 232 of the second atomic oscillator because of aging or production tolerance, the displacement of the object can be accurately determined.

### 1.7. Flowchart of First Embodiment

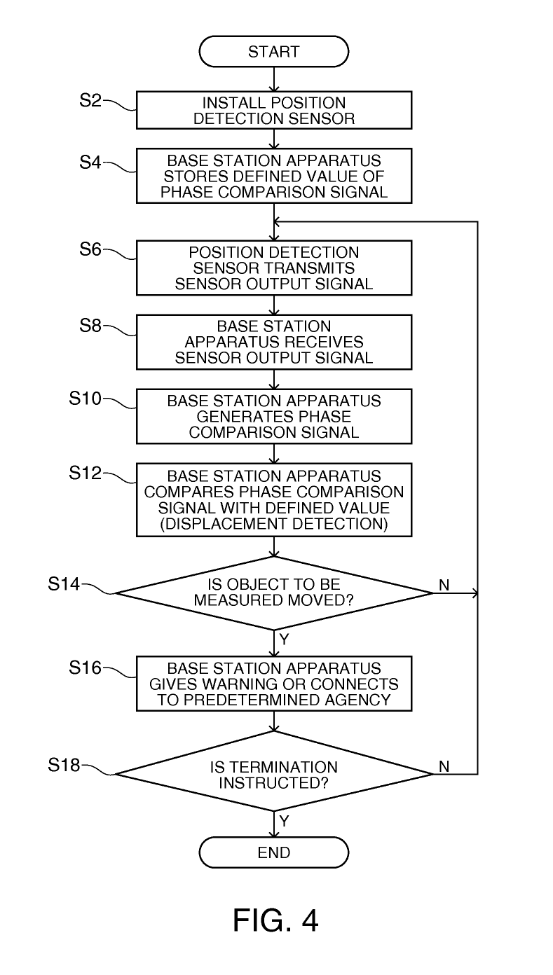

FIG. 4 illustrates a flowchart according to the first embodiment. The position detection system according to the first embodiment detects the signs of, for example, a cliff failure according to FIG. 4.

First, the position detection sensor 20 is installed in, for example, a cliff or the like (S2). Thereafter, the base station apparatus 30 wirelessly receives a sensor output signal obtained when the position detection sensor 20 is installed from the position detection sensor 20, obtains the defined value 236 of the phase comparison signal from the phase comparison signal 234, and stores the defined value 236 of the phase comparison signal in the storage 34 (S4).

A system starts observation, the position detection sensor 20 transmits the sensor output signal (S6), and the base station apparatus 30 receives the sensor output signal (S8). The base station apparatus 30 compares the sensor output signal 230 with the output 232 of the second atomic oscillator, and generates the phase comparison signal 234 (S10). Thereafter, the base station apparatus 30 compares the phase comparison signal 234 with the defined value 236 of the phase comparison signal, thereby determining whether the object is displaced and measuring the size of the displacement (S12).

When it is determined that the object to be measured is not moved, the process returns to step S6 again and observation is continued (S14N). When it is determined that the object to be measured is moved (S14Y), the base station apparatus 30 may give a warning in order to escape from danger or may connect to a predetermined disaster prevention agency (S16). Thereafter, when the termination of the observation is instructed, a series of processes are terminated (S18Y). Otherwise, the process returns to step S6 again, and the observation is continued (S18N). The position detection system according to the first embodiment realizes the stability of the signal and high accuracy by using the atomic oscillator. Further, the missing of sign is prevented by detecting not acceleration or the like but a position, and the detection accuracy is improved by performing comparison with the defined value. Further, a system with a small size and low power consumption is realized by using, particularly, the atomic oscillator in CPT method.

### 2. Second Embodiment

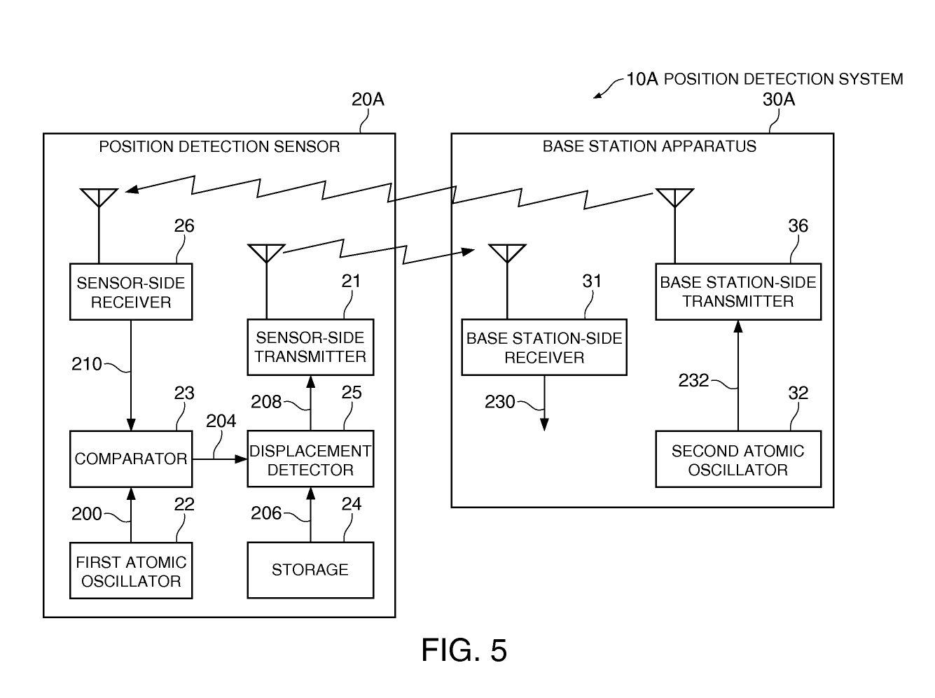

A second embodiment of the invention will be described with reference to FIGS. 5 and 6 and FIGS. 11A and 11B.

### 2.1. Example of Use of Position Detection System According to Second Embodiment

An example of the use of the position detection system according to the second embodiment will be described with reference to FIGS. 11A and 11B. Meanwhile, the description which is repeated in the first embodiment is omitted. FIG. 11A is a view illustrating an example in which the position detection system is used to detect the signs of a cliff failure. When there are signs of a cliff failure, the position detection sensor 20 moves together with the ground as shown in a dotted line, so that the distance from the base station apparatus 30 is varied.

FIG. 11B is a view illustrating the variation in a reference signal from the base station apparatus. Before the signs of a cliff failure appear, the position detection sensor 20 is positioned at a position corresponding to the solid line of FIG. 11A, and the position detection sensor 20 receives the reference signal indicated by “before movement” of FIG. 11B. However, after the position detection sensor 20 is moved together with the ground, the position detection sensor 20 receives the reference signal indicated by “after movement” of FIG. 11B. Unlike the first embodiment, the amount of movement of the position detection sensor 20 can be seen by detecting the phase difference Δθ in the sensor output signal “before movement” and the sensor signal “after movement” of FIG. 11B on the side of the position detection sensor 20.

### 2.2. Configuration of Position Detection System According to Second Embodiment

FIG. 5 is a block diagram illustrating a position detection system 10A according to the second embodiment. Meanwhile, the same reference numbers are used for the same elements in FIGS. 1 to 3, and a description thereof is omitted.

The position detection system 10A according to the second embodiment includes a position detection sensor 20A and a base station apparatus 30A. Unlike the first embodiment, the position detection sensor 20A includes a sensor-side receiver 26 which wirelessly receives a reference signal 210 from the base station apparatus 30A. Further, the position detection sensor 20A includes a comparator 23, storage 24, and a displacement detector 25, which are included in the base station apparatus according to the first embodiment. Meanwhile, unlike the first embodiment, the base station apparatus 30A according to the second embodiment includes a base station-side transmitter 36 which wirelessly transmits the reference signal. As described above, in the second embodiment, the position detection sensor 20A performs the signal comparison and the displacement detection which are performed by the base station apparatus in the first embodiment, so that the processes are not centered on the base station apparatus. For example, when the position detection system 10A is used to increase the number of position detection sensors in the future, a situation in which the whole process is delayed because the processes are centered on the base station apparatus can be avoided.

The position detection sensor 20A includes the sensor-side receiver 26, the comparator 23, the storage 24, the displacement detector 25, the sensor-side transmitter 21, and the first atomic oscillator 22. The sensor-side receiver 26 wirelessly receives the reference signal 210. Thereafter, the comparator 23 compares the phase of the reference signal 210 and the phase of the output 200 of the first atomic oscillator, and outputs a phase comparison signal 204 which is the result of the comparison. Here, the reference signal 210 according to the second embodiment corresponds to the output 232 of the second atomic oscillator of the base station apparatus 30A. Therefore, the comparator 23 is the same as the comparator 33 according to the first embodiment, and the phase comparison signal 204 is the same as the phase comparison signal 234 according to the first embodiment.

Further, the storage 24, the displacement detector 25, a defined value 206 of the phase comparison signal, and a signal 208 indicative of the displacement of the object are the same as the respective storage 34, the displacement detector 35, the defined value 236 of the phase comparison signal, and the signal 238 indicative of the displacement of the object in the first embodiment. In the second embodiment, the position detection sensor 20A wirelessly transmits the signal 208 indicative of the displacement of the object to the base station apparatus 30A using the sensor-side transmitter 21.

The base station apparatus 30A includes a base station-side receiver 31, a second atomic oscillator 32, and the base station-side transmitter 36. The base station-side receiver 31 wirelessly receives the sensor output signal. In the second embodiment, the sensor output signal 230 is the signal 208 indicative of the displacement of the object, unlike the first embodiment. That is, since the final result in which it is determined whether the object is displaced or not is wirelessly transmitted to the base station apparatus 30A, the base station apparatus 30A can, for example, rapidly give a warning against disaster or may connect to a predetermined agency. Further, the base station-side transmitter 36 wirelessly transmits the output 232 of the second atomic oscillator as the reference signal as described above.

### 2.3. Flowchart According to Second Embodiment

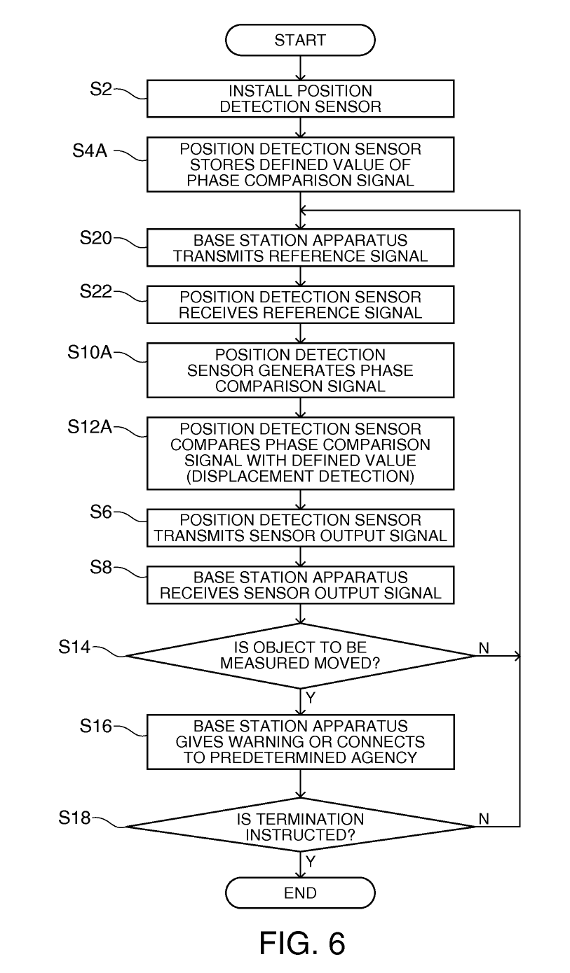

FIG. 6 illustrates a flowchart according to the second embodiment. The position detection system according to the second embodiment detects the signs of, for example, a cliff failure according to FIG. 6. Meanwhile, the same reference numerals are used for the same steps in FIG. 4, and a description thereof is omitted.

In the second embodiment, the position detection sensor 20A wirelessly receives the reference signal from the base station apparatus 30A when the position detection sensor 20A is installed, obtains the defined value 206 of the phase comparison signal from the phase comparison signal 204, and then stores the defined value 206 of the phase comparison signal in the storage 24 (S4A).

The system starts observation, the base station apparatus 30A wirelessly transmits the reference signal (S20), and the position detection sensor 20A receives the reference signal (S22). In the second embodiment, the position detection sensor 20A compares the reference signal 210 and the output 200 of the first atomic oscillator, and generates the phase comparison signal 204 (S10A). Thereafter, the position detection sensor 20A determines whether the object is displaced by comparing the phase comparison signal 204 and the defined value 206 of the phase comparison signal, and measures the size of the displacement (S12A). Thereafter, the position detection sensor 20A transmits the result of the measurement as the sensor output signal (S6), and the base station apparatus 30A receives the sensor output signal (S8).

When it is determined that the object to be measured is not moved, the base station apparatus 30A returns to step S20 again, and continues the observation (S14N). When it is determined that the object to be measured is moved (S14Y), the base station apparatus 30A gives a warning and makes a connection (S16). Thereafter, when the termination of the observation is instructed, the series of processes are terminated (S18Y). Otherwise, the process returns to step S20 and the observation is continued (S18N). In the second embodiment, the position detection sensor performs the comparison on signals and the detection of displacement, thereby enabling distributed processing in which the processes are not centered on the base station apparatus.

### 3. Third Embodiment

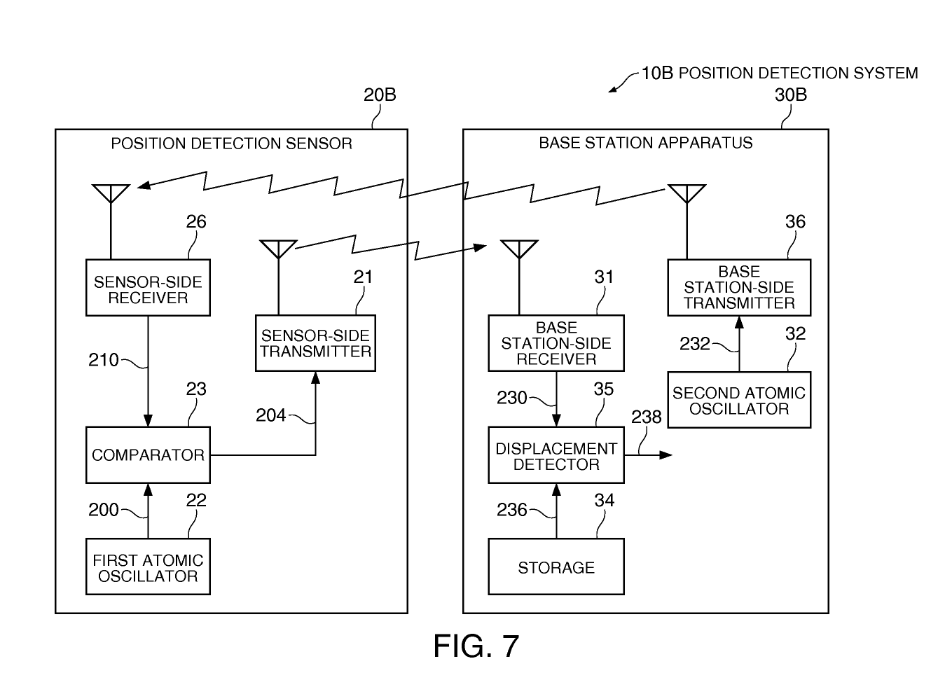

A third embodiment of the invention will be described with reference to FIG. 7. Meanwhile, the method of using the position detection system according to the third embodiment is the same as in the second embodiment (refer to FIGS. 11A and 11B).

### 3.1. Configuration of Position Detection System According to Third Embodiment

FIG. 7 is a block diagram illustrating a position detection system 10B according to the third embodiment. Meanwhile, the same reference numbers are used for the same elements in FIGS. 1 to 3 and FIG. 5, and a description thereof is omitted.

The position detection system 10B according to the third embodiment includes a position detection sensor 20B, and a base station apparatus 30B. The position detection sensor 20B does not include a displacement detector and storage unlike the second embodiment, and the functions thereof are included in the base station apparatus 30B like the first embodiment.

In the third embodiment, the comparator 23 is included in the position detection sensor 20B, so that the processing load is not centered on the base station apparatus 30B like the first embodiment. Further, the position detection sensor 20B does not include the storage 34, thereby enabling the size and power consumption of a circuit to be reduced. Further, the position detection sensor 20B does not include storage, such as a memory, thereby enabling the cost of the position detection sensor 20B to be lowered, compared to the second embodiment.

The position detection sensor 20B according to the third embodiment, the sensor-side transmitter 21 wirelessly transmits the phase comparison signal 204 to the base station apparatus 30B. In the base station apparatus 30B according to the third embodiment, the base station-side receiver 31 receives the sensor output signal 230 which is the phase comparison signal 204. Thereafter, the displacement detector 35 compares the sensor output signal 230 and the defined value 236 of the phase comparison signal which is stored in the storage 34, and outputs the signal 238 indicative of the accurate displacement of an object.

### 4. Modification

Although the case where a single position detection sensor is used has been illustrated in the descriptions of the first to third embodiments, a plurality of position detection sensors may be present in the embodiments. At this time, the necessity of determining by which position detection sensor a signal is transmitted arises on the side of the base station. Modifications, which will be described below, relate to a position detection system and a position detection sensor to which a unit which enables the side of the base station to distinguish between the position detection sensors is added. Meanwhile, although the modification will be described based on the first embodiment for convenience of explanation, all the modifications which will be described later can be applied to all of the first to third embodiments. At this time, it is assumed that the defined value of the phase comparison signal is obtained from each position detection sensor. Further, although two position detection sensors are shown in the drawing, the number of position detection sensors is not limited to two.

### 4.1. First Modification

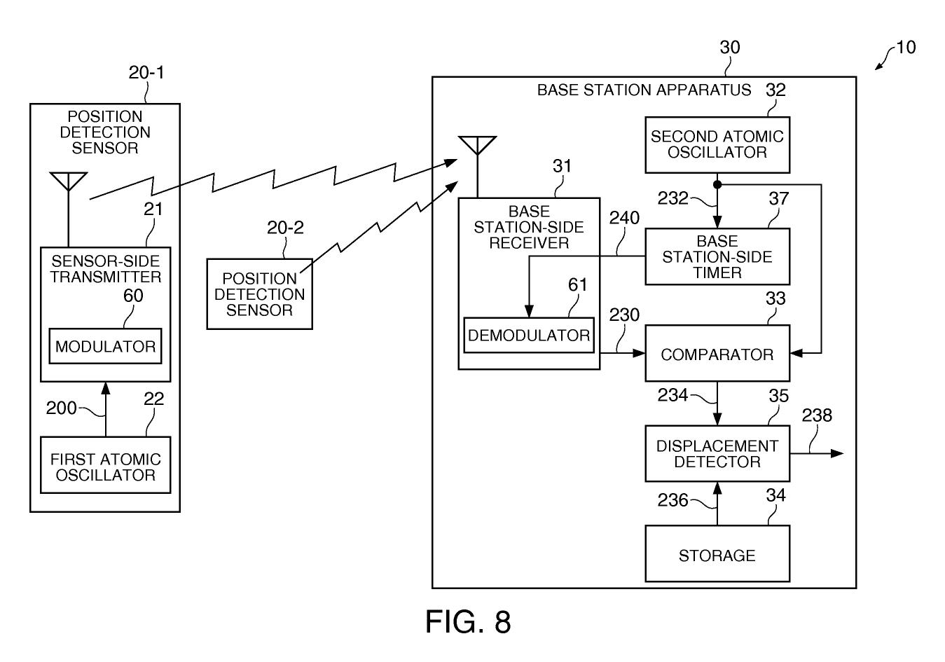

A first modification of the invention will be described with reference to FIG. 8. Meanwhile, the same reference numbers are used for the same elements in FIGS. 1 to 7, and a description thereof is omitted. A position detection system 10 according to the first modification includes a modulator 60 and a demodulator 61, so that a base station apparatus 30 can distinguish between position detection sensors 20-1 and 20-2. Although, for example, amplitude modulation or frequency modulation can be used, the method is not limited to a specific method. In the first modification, description will be made using the frequency modulation. Meanwhile, although the inside of the position detection sensor 20-2 is not illustrated, the configuration thereof is the same as that of the position detection sensor 20-1.

Each of the plurality of position detection sensors 20-1 and 20-2 includes the modulator 60 in a sensor-side transmitter 21. A sensor output signal is transmitted to each of the position detection sensors at a unique frequency using the modulator 60. In the base station apparatus 30, the demodulator 61 is included in a base station-side receiver 31. For example, the base station apparatus 30 may include a base station-side timer 37 which performs timekeeping based on output 232 of the second atomic oscillator. The demodulator 61 may switch to a receivable frequency in response to a time signal 240 from the base station-side timer 37, and may receive the sensor output signals from the position detection sensors 20-1 and 20-2 in time division manner. In the first modification, the base station apparatus 30 can distinguish between the plurality of position detection sensors by only adding a small number of circuits.

### 4.2. Second Modification

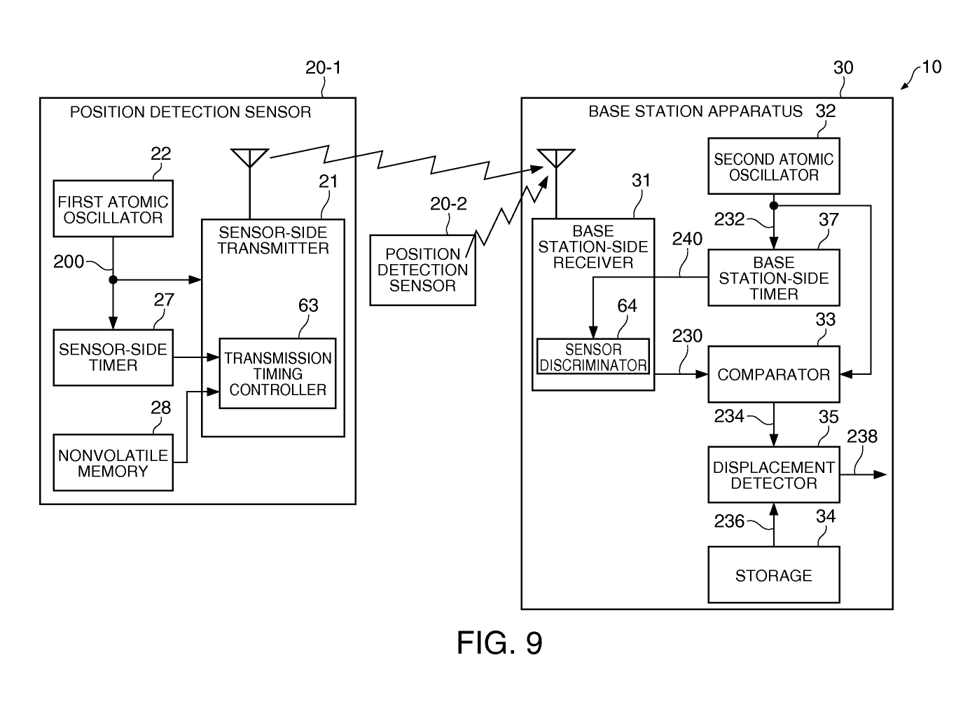

A second modification of the invention will be described with reference to FIG. 9. Meanwhile, the same reference numbers are used for the same elements in FIGS. 1 to 8, and a description thereof is omitted. In a position detection system 10 according to the second modification, position detection sensors 20-1 and 20-2 and a base station apparatus 30 perform transmission and reception based on common time information in time division manner. Meanwhile, although the inside of the position detection sensor 20-2 is not illustrated, the configuration thereof is the same as that of the position detection sensor 20-1.

The position detection sensors 20-1 and 20-2 and the base station apparatus 30 respectively include a sensor-side timer 27 and a base station-side timer 37 which perform timekeeping based on the outputs of respective atomic oscillators which are highly accurate and stable. For example, current time information may be output from these timers. Since atomic oscillators are used, infallible current time information can be obtained for a long period by setting these timers once during, for example, manufacturing or shipping.

The position detection sensor 20-1 or 20-2 may include a nonvolatile memory 28. A transmittable time which is uniquely assigned to each position detection sensor may be recorded in the nonvolatile memory 28. For example, the transmittable time of the position detection sensor 20-1 may be recorded as in the range of 0 to 4 seconds and the transmittable time of the position detection sensor 20-2 may be recorded as in the range of 5 to 9 seconds.

The position detection sensor 20-1 or 20-2 includes a transmission timing controller 63, which controls a transmission timing based on the current time information of the sensor-side timer 27 and the transmittable time of the nonvolatile memory 28, in the sensor-side transmitter 21. Thereafter, the position detection sensor 20-1 or 20-2 wirelessly transmits a sensor output signal in time division manner.

The base station-side receiver 31 of the base station apparatus 30 includes a sensor discriminator 64 which distinguishes between sensor output signals from the position detection sensors. The sensor discriminator 64 distinguishes between the position detection sensors by referring to the current time information 240 of the base station-side timer 37 and the transmittable time of each position detection sensor. Meanwhile, the sensor discriminator 64 may include, for example, a nonvolatile memory (not shown), and may store information about the transmittable time of each position detection sensor in the nonvolatile memory.

The second modification uses the characteristics of a system in that accurate common current time information can be easily obtained because both the position detection sensor and the base station apparatus include the highly accurate atomic oscillators. Further, the transmittable time can be set using the nonvolatile memory 28, thereby enabling a flexible system which can easily respond to the increase or decrease in the number of position detection sensors.

### 4.3. Third Modification

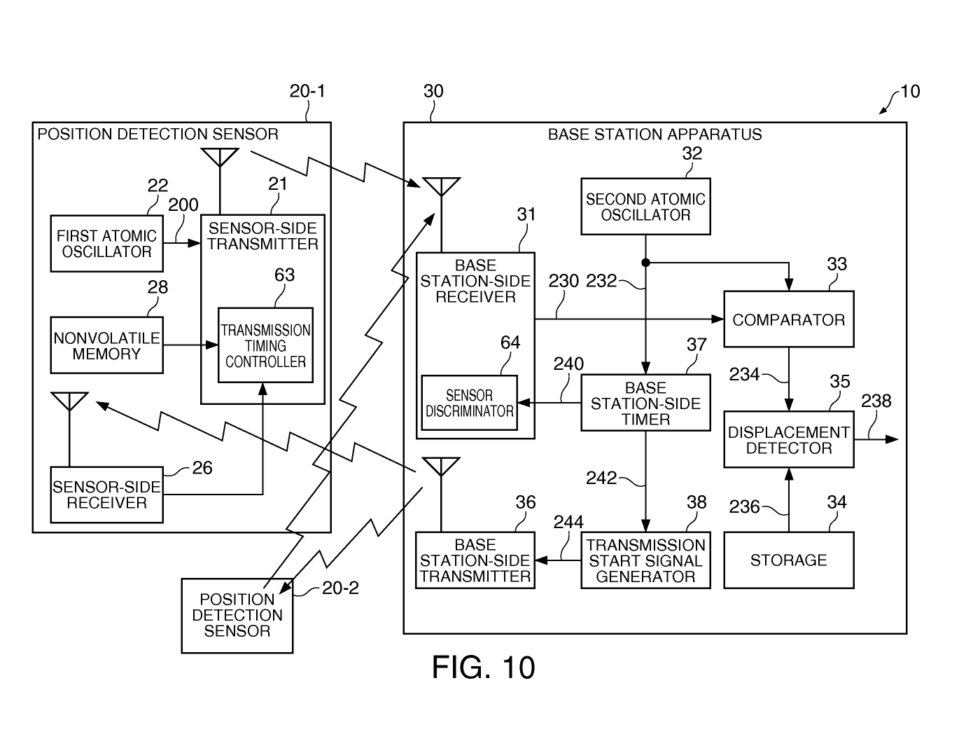

A third modification of the invention will be described with reference to FIG. 10. Meanwhile, the same reference numbers are used for the same elements in FIGS. 1 to 9, and a description thereof is omitted. In a position detection system 10 according to the third modification, position detection sensors 20-1 and 20-2 receive a transmission start signal from the base station apparatus 30 and then each position detection sensor performs transmission after a time that is unique to the position detection sensor elapses, so that the position detection sensors can be distinguished. Meanwhile, although the inside of the position detection sensor 20-2 is not illustrated, the configuration thereof is the same as that of the position detection sensor 20-1.

The transmission start signal generator 38 of the base station apparatus 30 generates a transmission start signal 244 in response to the time signal 242 of the base station-side timer 37 or based on an external instruction (not shown), such as manual button operation, as shown in FIG. 10. The base station-side transmitter 36 wirelessly transmits a transmission start signal 244 in order to cause the position detection sensors 20-1 and 20-2 to start the transmission of the sensor output signal.

The position detection sensor 20-1 or 20-2 includes a sensor-side receiver 26 which receives the transmission start signal 244. Meanwhile, the sensor-side receiver 26 may include a separator in order to separate the transmission start signal 244 from another signal. Further, the position detection sensor 20-1 or 20-2 may include a nonvolatile memory 28, and transmittable time which is uniquely assigned to each position detection sensor may be recorded in the nonvolatile memory 28 like the second modification. The transmittable time according to the third modification may be defined as, for example, 0 to 4 seconds after the transmission start signal is received. The transmission timing controller 63 controls the transmission timing of sensor output data by receiving a timing signal in which a transmission start signal is received from the sensor-side receiver and, further, receiving the transmittable time from the nonvolatile memory 28.

A reception station 30 can distinguish between signals transmitted from the position detection sensors 20-1 and 20-2 by performing timekeeping on elapsed time after the transmission start signal is transmitted based on, for example, the time information 240.

In the third modification, the base station apparatus 30 can request the transmission of data from the position detection sensor at an appropriate timing. Further, the transmittable time can be set in the nonvolatile memory 28, thereby allowing a flexible system which can easily respond to the increase and decrease in the number of position detection sensors. Meanwhile, the position detection sensor may reduce power consumption by stopping the unnecessary operation of circuits until the transmission start signal is received.

Meanwhile, in each of the embodiments and modifications, header information which is unique to each position detection sensor may be included in the sensor output signal. The unique header information may be, for example, Identification (ID) or time information in transmission. The base station apparatus may distinguish between the respective position detection sensors based on the header information, and may use the header information for checking errors when the header information is received. Further, in the third modification, the base station apparatus 30 may transmit the transmission start signal which includes the header information in order to separately designate the position detection sensors. At this time, each position detection sensor can determine whether to transmit the sensor output signal based on the header information.

The invention is not limited to these examples, and includes a configuration which is substantially the same as the configuration described in the embodiments (for example, a configuration in which the function, method, or result thereof is the same or a configuration in which the object or effect is the same). Further, the invention includes a configuration which replaces the nonessential part of the configuration which is described in the embodiment. Further, the invention includes a configuration which can realize the same effect as that of the configuration which is described in the embodiments or a configuration which enables the same aspect to be achieved. Further, the invention includes a configuration in which a well-known technology is added to the configuration described in the embodiment.

The entire disclosure of Japanese Patent Application No. 2011-060629, filed Mar. 18, 2011 is expressly incorporated by reference herein.

What is claimed is:

1. A position detection system, comprising:
a position detection sensor which includes a first atomic oscillator and a sensor-side transmitter, and outputs a sensor output signal;
a base station apparatus which includes a base station-side receiver, which wirelessly receives the sensor output signal, and a second atomic oscillator;
a comparator which compares a phase of an output signal from the first atomic oscillator and a phase of an output signal from the second atomic oscillator, and outputs a phase comparison signal;
a storage which stores a defined value of the phase comparison signal; and
a displacement detector which detects displacement of the position detection sensor by comparing the phase comparison signal and the defined value.

2. The position detection system according to claim 1,
wherein the base station apparatus includes the comparator, the storage, and the displacement detector.

3. The position detection system according to claim 1,
wherein the position detection sensor includes:
a sensor-side receiver which wirelessly receives a reference signal from the base station apparatus;
the comparator which compares the reference signal with the output signal from the first atomic oscillator, and then outputs the phase comparison signal;
the displacement detector;
the storage; and
the sensor-side transmitter which wirelessly transmits the output signal of the displacement detector as the sensor output signal, and
wherein the base station apparatus includes:
the base station-side receiver which wirelessly receives the sensor output signal; and
a base station-side transmitter which generates the reference signal based on output from the second atomic oscillator, and wirelessly transmits the reference signal.

4. The position detection system according to claim 1,
wherein the position detection sensor includes:
the comparator; and
the sensor-side transmitter which wirelessly transmits the phase comparison signal as the sensor output signal, and
wherein the base station apparatus includes:
the storage;
the base station-side receiver which wirelessly receives the phase comparison signal which is wirelessly transmitted from the sensor-side transmitter; and
the displacement detector which detects the displacement of the position detection sensor by comparing the phase comparison signal which is wirelessly received using the base station-side receiver with the defined value of the phase comparison signal.

5. The position detection system according to claim 1, comprising a plurality of position detection sensors.

6. The position detection system according to claim 5,
wherein the sensor-side transmitter includes a modulator which modulates the sensor output signal using a frequency which is different for each position detection sensor, and
wherein the base station-side receiver includes a demodulator which demodulates the modulated sensor output signal.

7. The position detection system according to claim 5,
wherein the position detection sensor includes a timer which performs timekeeping based on the output from the first atomic oscillator, and
wherein each sensor-side transmitter includes a transmission timing controller which controls transmission timing such that the sensor output signal is wirelessly transmitted at a different timing based on output of the timer.

8. The position detection system according to claim 5,
wherein the base station apparatus includes a unit which wirelessly transmits a transmission start signal, used to permit the transmission of the sensor output signal, to the position detection sensor, and
wherein each position detection sensor includes:
a unit which wirelessly receives the transmission start signal; and
a transmission timing controller which controls a transmission timing such that the sensor output signal is wirelessly transmitted at a different timing that is different from that of another position detection sensor based on the transmission start signal.

9. A position detection sensor which is used in the position detection system according to claim 1.
